(19) United States
(12) Patent Application Publication
(10) Pub. No.: US 2023/0264532 A1
(43) Pub. Date: Aug. 24, 2023

(54) MULTI-AXIS CONTROL OF CONTROL VALVES IN A HI-RAIL DEVICE

(71) Applicant: CONTINENTAL RAILWORKS TECHNOLOGY I INC., Saint-Laurent (CA)

(72) Inventors: François AUBÉ, Montreal (CA); Nicholas GROMAK, Vaudreuil-Dorion (CA)

(21) Appl. No.: 17/680,162

(22) Filed: Feb. 24, 2022

(51) Int. Cl. B60F 1/04

(52) U.S. Cl. CPC B60F 1/04; B60F 2301/02

(57) ABSTRACT

An apparatus and a method for controlling sequential unlocking, deployment or retraction, and locking of a hi-rail gear unit. There is a valve system in which some of the valves are configured to actuate a deployment cylinder that deploys or retracts the hi-rail device, wherein some of the valves are configured to actuate a locking cylinder that locks or unlocks the hi-rail gear unit deployed or retracted; said actuations being independent from each other. A multi-axis controller is connected to the valve system and has a rod configured to move freely by pivoting, the positions of the first multi-axis controller including a first lock position, a first unlock position, a first engaged position and a first disengaged position. A guiding forces the rod along a locking axis prior to permitting movement of the rod along a deployment axis to force unlocking before deployment or retraction.

### TECHNICAL FIELD

The present disclosure relates to hi-rail devices. More specifically, it relates to improvement of operation of control valves for high-rail devices.

### BACKGROUND

Hi-rail vehicles are vehicles known to be operable on both rail tracks and road, hence their name: hi-rail, high-rail, or road-rail vehicles.

In practice, hi-rail vehicles are often normal road vehicles, such as a pick-up truck or a specialized vehicle (tractor, excavator, etc.), converted into a hi-rail vehicle by adding a hi-rail device to the vehicle to allow the vehicle to drive on rail tracks.

Hi-rail devices typically comprise a mechanism rotating the wheels from a road position to a rail position. When the rotation mechanism is actuated, the rail wheels are moved from a position in which they are stowed, e.g., under the vehicle, into a position in which they are deployed on the rail tracks.

A particular case may include vertical hi-rail devices, which aim at reducing the extent to which the stowed wheels and related mechanism occupy space underneath the vehicle. Vertical hi-rail devices avoid rotating the wheels for stowing or deployment, and rather provide a vertical (up-down) movement of the wheel assembly, and no rotation thereof, in the same circumstances. This allows a reduction of the longitudinal mounting envelope, and therefore offers more space for mounting other equipment on the vehicle.

As for other transportation means, safety issues are taken seriously and various aspects of vertical hi-rail devices need to be improved to ensure maximum safety to the drivers of high-rail vehicles and operators of hi-rail devices, including at the time of switching between configurations of the hi-rail device.

### SUMMARY

According to an aspect of the disclosure, there is provided an apparatus for controlling deployment of a hi-rail gear unit, the system comprising:
a valve system having a plurality of valves, wherein some of the valves are configured to actuate a deployment cylinder that deploys the hi-rail gear unit in a deployment configuration or retracts the hi-rail gear unit in a retraction configuration mechanically in response to being actuated, wherein some of the valves are configured to actuate a locking cylinder that locks or unlocks the hi-rail gear unit in one of said configurations in response to being actuated;
a first multi-axis controller connected to the valve system and having a first rod configured to move freely by pivoting on a first base from, towards and about a first rod central axis, the positions of the first multi-axis controller including a first lock position, a first unlock position, a first engaged position and a first disengaged position; and
a mechanical linkage plate attached to the valve system, the mechanical linkage plate having a first aperture configured to receive the first rod and to force the first rod along a first locking axis prior to permitting movement of the first rod along a first deployment axis.

According to an embodiment, the aperture has a form of a “T”.

According to an embodiment, the first base is attached to the valve system.

According to an embodiment, the first locking axis and the first deployment axis are approximately perpendicular to, and are both approximately perpendicular to the first rod central axis.

According to an embodiment, the valve system locks the hi-rail gear when the first rod is in the first lock position; and the valve system unlocks the hi-rail gear when the first rod is in the first unlock position.

According to an embodiment, the valve system moves the hi-rail gear up when the first rod is in the first disengaged position; and the valve system moves the hi-rail gear down when the first rod is in the first engaged position.

According to an embodiment, the first aperture is configured to guide the first rod only 1) between the first lock position and the first unlock position, 2) between the first unlock position and the first engaged position, and 3) between the first unlock position and the first disengaged position, while prohibiting a guiding of the first rod between other positions.

According to an embodiment, the deployment cylinder is a hydraulic cylinder which unfolds for deployment or folds for retraction arms forming a linkage of the hi-rail gear unit.

According to an embodiment, the locking cylinder is a hydraulic cylinder comprising a compression spring for safety and which holds the arms forming the linkage of the hi-rail gear unit either unfolded in deployment or folded in retraction.

According to an embodiment, there is further provided a second multi-axis controller attached to the valve system via a second base, the second multi-axis controller having a second rod configured to move freely by pivoting on a second base from, towards and about a second rod central axis, and wherein the mechanical linkage plate has a second aperture configured to receive the second rod and to force the second rod along a second locking axis prior to permitting movement of the second rod along a second deployment axis, the second locking axis and the second deployment axis being approximately perpendicular to the second rod central axis.

According to another aspect of the disclosure, there is provided a method for controlling sequential unlocking, deployment or retraction, and locking of a hi-rail gear unit, the system comprising:
providing a valve system having a plurality of valves, wherein some of the valves are configured to actuate a deployment cylinder that deploys the hi-rail gear unit in a deployment configuration or retracts the hi-rail gear unit in a retraction configuration mechanically in response to being actuated, wherein some of the valves are configured to actuate a locking cylinder that locks or unlocks the hi-rail gear unit in one of said configurations in response to being actuated;
connecting a first multi-axis controller to the valve system and having a first rod configured to move freely by pivoting on a first base from, towards and about a first rod central axis, the positions of the first multi-axis controller including a first lock position, a first unlock position, a first engaged position and a first disengaged position; and
guiding the first rod on the first multi-axis controller by using a mechanical linkage plate attached to the valve system, the mechanical linkage plate having a first aperture configured to receive the first rod and to force the first rod along a first locking axis prior to permitting movement of the first rod along a first deployment axis.

According to an embodiment, guiding the first rod comprises using the aperture having a form of a “T”.

According to an embodiment, there is further provided attaching the first base to the valve system.

According to an embodiment, guiding the first rod comprises providing the first locking axis approximately perpendicular to the first deployment axis and approximately perpendicular to the first rod central axis.

According to an embodiment, there is further provided locking the hi-rail gear using the valve system when the first rod is in the first lock position; and unlocking the hi-rail gear using the valve system when the first rod is in the first unlock position.

According to an embodiment, there is further provided retracting the hi-rail gear unit up using the valve system when the first rod is in the first disengaged position; and deploying the hi-rail gear unit down using the valve system when the first rod is in the first engaged position.

According to an embodiment, guiding the first rod comprises using the first aperture which is configured to guide the first rod only 1) between the first lock position and the first unlock position, 2) between the first unlock position and the first engaged position, and 3) between the first unlock position and the first disengaged position, while prohibiting a guiding of the first rod between other positions.

According to an embodiment, actuating the deployment cylinder comprises actuating a hydraulic cylinder which unfolds for deployment or folds for retraction arms forming a linkage of the hi-rail gear unit.

According to an embodiment, actuating the locking cylinder comprises actuating a hydraulic cylinder comprising a compression spring for safety and which holds the arms forming the linkage of the hi-rail gear unit either unfolded in deployment or folded in retraction.

According to an embodiment, there is further provided providing a second multi-axis controller attached to the valve system via a second base, the second multi-axis controller having a second rod configured to move freely by pivoting on a second base from, towards and about a second rod central axis, and wherein the guiding comprises provided a mechanical linkage plate that has a second aperture configured to receive the second rod and to force the second rod along a second locking axis prior to permitting movement of the second rod along a second deployment axis, the second locking axis and the second deployment axis being approximately perpendicular to each other.

### BRIEF DESCRIPTION OF THE DRAWINGS

Further features and advantages of the present disclosure will become apparent from the following detailed description, taken in combination with the appended drawings, in which:

FIG. 1A depicts a hi-rail gear device having deployment cylinders and locking cylinders, deployed in rail position, according to an embodiment;

FIG. 1B depicts a hi-rail gear device having deployment cylinders and locking cylinders, retracted in road position, according to an embodiment;

FIG. 2A depicts a perspective view of a system for controlling deployment of a hi-rail gear when the hi-rail gear is locked, in accordance with at least one embodiment of the present disclosure;

FIG. 2B depicts another perspective view of the system of FIG. 2A when the hi-rail gear is unlocked, in accordance with at least one embodiment of the present disclosure;

FIG. 2C depicts another perspective view of the system of FIG. 2B;

FIG. 3 depicts a portion of perspective view of the system of FIG. 2A;

FIG. 4A depicts a perspective view of the system of FIG. 2A when the hi-rail gear is both unlocked and disengaged/retracted, in accordance with at least one embodiment of the present disclosure;

FIG. 4B depicts another perspective view of the system of FIG. 3A;

FIG. 4C depicts a perspective view of the system of FIG. 2A when the hi-rail gear is both unlocked and engaged/deployed, in accordance with at least one embodiment of the present disclosure;

FIG. 5A depicts a perspective view of a multiple-rod system when the hi-rail dual gear is locked, in accordance with at least one embodiment of the present disclosure;

FIG. 5B depicts a perspective view of a plate of the system of FIG. 5A, in accordance with at least one embodiment of the present disclosure;

FIG. 6A depicts a perspective view of the system of FIG. 5A when the hi-rail gear is unlocked, in accordance with at least one embodiment of the present disclosure

FIG. 6B depicts a perspective view of the system of FIG. 5A when the hi-rail gear is disengaged/retracted, in accordance with at least one embodiment of the present disclosure;

FIG. 6C depicts a perspective view of the system of FIG. 5A when the hi-rail gear is engaged/deployed, in accordance with at least one embodiment of the present disclosure;

FIG. 6D depicts a perspective view of the system of FIG. 5A when one rod is in engaged/deployed position and another rod is in disengaged/retracted position, for example if only one of the hi-rail gears is deployed and the other is retracted, in accordance with at least one embodiment of the present disclosure.

FIG. 7 depicts a cross section of the valve system with the user-actuatable levers, in accordance with at least one embodiment of the present disclosure; and

FIG. 8 depicts a schematic view of possible lever configurations for two levers, with the guiding constraints of the plate which limit actual lever movement shown in thick lines, in accordance with at least one embodiment of the present disclosure.

It will be noted that throughout the appended drawings, like features are identified by like reference numerals.

### DETAILED DESCRIPTION

Various aspects of the present disclosure generally address one or more of the problems of safety and convenience in unlocking and deploying of a hi-rail gear.

To lower the high-rail wheels to their operation position, conventional high-rail vehicles have a lowering mechanism, usually implemented using a deployment device and a locking mechanism. The locking mechanism has been previously implemented with a locking pin operated manually. Such manual operation of the locking pin is not convenient for the operators. It can be forgotten in place, or its insertion may be forgotten, and it can break due to shearing forces.

Moreover, in such conventional systems, the lowering mechanism to switch the configuration of the hi-rail device is uncoupled from the locking or unlocking, such that the deployment can be initiated when the hi-rail device is still locked, resulting in forces in the locking mechanism which can break the locking mechanism.

Alternatively, a hydraulic cylinder may be used as a locking mechanism. This locking cylinder may comprise a spring in compression to act as a natural locker to provide the default configuration of the locking cylinder as in extension. Reference is made to U.S. application 62/622,342, incorporated herein by reference.

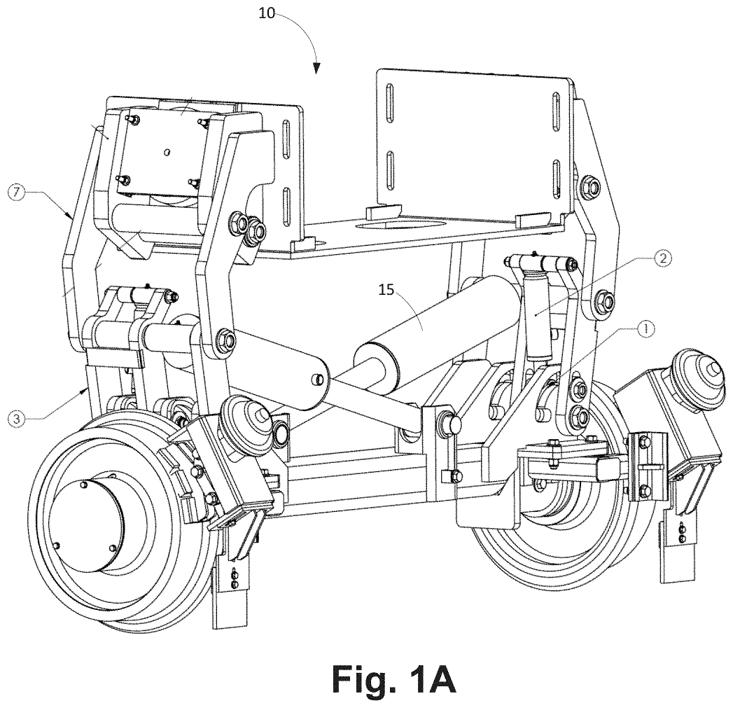

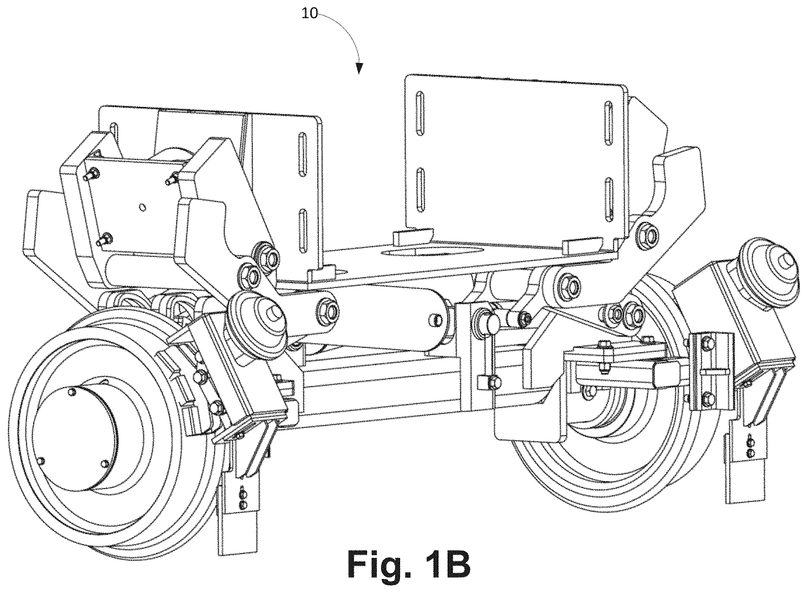

FIGS. 1A and 1B illustrate a hi-rail device 10 is deployed configuration (FIG. 1A) and retracted configuration (FIG. 1B). By actuating deployment cylinders 15, the hi-rail device can be deployed by opening or unfolding arms (3, 7) of the hi-rail device 10 and pushing the wheels downwardly. By retracting the deployment cylinders 15, the hi-rail device can be retracted by swiveling back and folding the arms (3 7) of the hi-rail device 10 and pulling the wheels upwardly.

The configuration of the arms (3, 7) in a folded (retracted) or unfolded (deployed) configuration can be locked in place using the locking cylinder 2 which has an end secured to a captive pin which is guided along a locking slot 1, the ends of which retain said captive pin to define the locked position of the captive pin in both configurations.

More specifically, the locking slot comprises a first locking end and a second locking end, the locking slot extending continuously from the first locking end to the second locking end, and the locking pin is movable in translation within the locking slot 1. The locking pin being captured within the locking slot, and travels only confined within contours of the locking slot 1 which guide the locking pin from the first locking end to the second locking end.

The locking cylinder 2 is connected to the locking pin. According to an embodiment, the locking cylinder comprising a spring to urge the locking pin into an abutting surface of any one of the first locking end and the second locking end when the locking pin is in any one of the first locking end or the second locking end, thereby locking arms (3, 7) forming the linkage of the hi-rail device.

While the spring acts as a safety in the locking cylinder, the licking cylinder 2 may actually be extended hydraulically to perform more adequate locking by being hydraulically forced to be in extension.

Therefore, there are deployment cylinders 15 which control deployment and retraction of the hi-rail device, and locking cylinders 2 which control the locked or unlocked configuration of the hi-rail device.

To ensure that the hi-rail gear unit unlocks prior to deploying or retracting, a complex hydraulic circuit usually requires several sequence valves. However, implementing several valves in a sequence may encounter challenges due to the complexity, as well as an increased risk of failure.

The system described herein forces the operator to actuate the locking mechanism, ensuring that the hi-gear unit is properly unlocked first, and only after the hi-gear unit is unlocked, permitting to deploy the cylinders down, or retract them up.

A mechanical linkage plate as described herein limits the movements of a rod attached to the valve and permits controlling the locking and unlocking and deployment of the hi-gear unit in a safer manner compared to the prior art means of control.

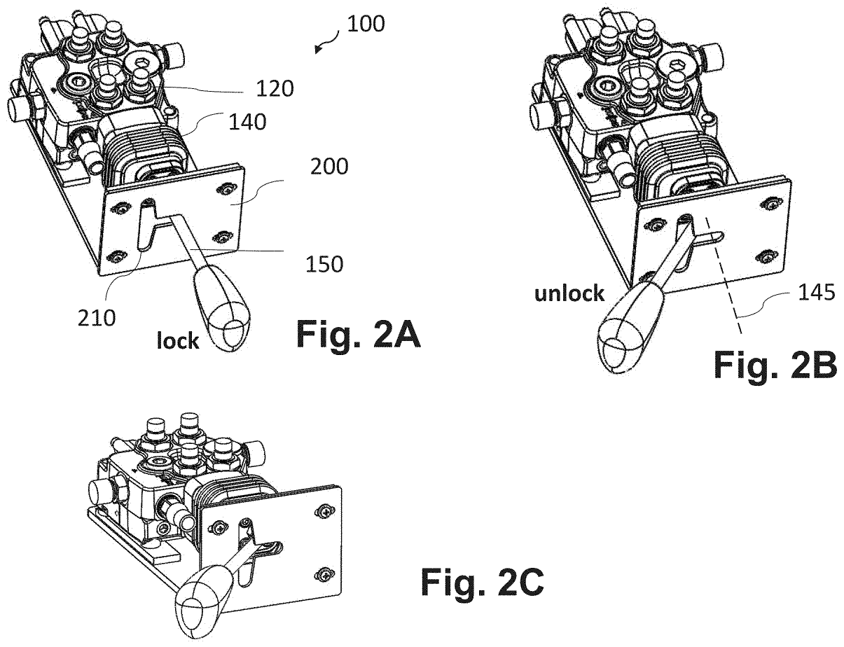

Referring now to the drawings, FIG. 2A depicts a system 100 for controlling deployment of a hi-rail gear unit and more specifically controlling the actuation of hydraulic cylinders (for deployment and for locking), in accordance with at least one embodiment of the present disclosure.

The system 100 has a valve system 120 configured to deploy/retract the hi-rail gear unit mechanically in response to being actuated, or configured to hydraulically lock or unlock the locking cylinder mechanically in response to being actuated, depending on which one is being actuated, since both the deployment cylinders 15 and the locking cylinders 2 can be actuated independently using their own hydraulic circuit and corresponding valves.

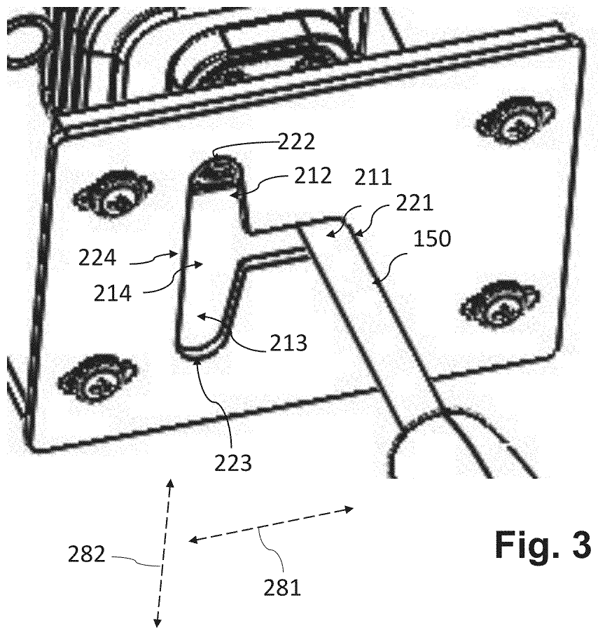

According to an embodiment, the valve system 120 is operated by a multi-axis controller 130 which has a base 140 and a rod 150. The base 140 is mounted on the valve system 120. The rod 150 is configured to move by pivoting on the base 140 from, towards and about a rod central axis 145 (depicted in FIG. 3).

The positions of the rod 150 include and are not limited to four positions: a lock position (as, for example, depicted in FIG. 2A), an unlock position (as, for example, depicted in FIG. 2A) without any determined engagement, an engaged (deployed on the ground=down=on) position and a disengaged (retracted=stored=up=off) position.

The system 100 has a mechanical linkage plate 200. The mechanical linkage plate 200 (also referred to herein as a “plate”) has an aperture 210 configured to receive the rod 150 such that movements of the rod 150 are limited by the edges 222 of the aperture 210. The aperture 210 has 3 ends 211, 212, 213 with 3 end edges 221, 222, 223. To move the rod 150 from any one end 211, 212, 213 to another one, the rod has to pass through an intermediate opening 214 which connects all three ends 211, 212, 213 of the aperture 210.

In other terms, when the rod is not engaged with the aperture of the plate 200, the rod 150 can move freely in any direction about the rod central axis 145. The aperture of the plate 200 as described herein acts as a guide and restricts such movement of the rod 150 to the perimeter of the aperture and thus the rod 150 may move within the edges of the aperture between lock and unlock positions and between engaged and disengaged positions, and such that the rod needs to be moved to the unlock position prior to be allowed to be moved to an engaged position or a disengaged position. Thus, such aperture is configured to guide the rod 150 1) between lock and unlock positions, 2) between unlock and engaged position, and 3) between the unlock and disengaged position. The rod is captive and can only translate within the guide formed in the plate 200 defining the four positions, by translating between said positions while continuously remaining within the guide.

Due to the specific connection of the valve to the multi-axis controller 130, when the rod 150 is in the lock position, the hi-rail gear unit is locked and cannot be deployed. The valve restricts any movement of the hi-rail gear unit. When the rod 150 is in the unlock position, the locking cylinder 2 is retracted, as allowed to do so by the valves controlling the actuation of the locking cylinder 2 being actuated using the dedicated hydraulic circuit therefor. The rod can then be displaced up or down, in order to retract or deploy the hi-rail device, respectively. This is made possible by the guide in the plate 200, which allows said displacement only when the rod has reached the unlock position first, thereby unlocking the system. Doing this involves the valves controlling the actuation of the deployment cylinder 15 perform the actuation using the dedicated hydraulic circuit therefor. Once this is done, the operator can bring back the rod or lever to the lock position, first by translating the rod vertically to the unlock position at the cross of the guide and then translate it horizontally to lock it again while the system is in a desired configuration as determined by the last deployment or retraction that was made with the same rod. The rod is therefore back to the lock position, but the hi-rail device 10 remains in the configuration as set by the last engagement or disengagement from the vertical translation of the rod in the guide of the plate 200.

FIG. 3 illustrates the two axes, namely the horizontal axis 281 which serves locking and unlocking, and the vertical axis 282 which servers deployment or retraction when the ultimate position is reached (the configuration of which is maintained when the rod is brought only to the unlock position for eventual locking, without reaching the opposed end of the vertical axis 282).

The multi-axis controller 130 is enabled for free multi-axis translation and therefore requires the guide made by the aperture forming the guide in the plate 200 to ensure that the translation is only along one axis at a given time, and never two or more, constraining the multi-axis controller 130 to a single-axis translation at a given time thanks to the guide.

Specifically, when the rod 150 abuts the first end edge 221, such position of the rod 150 forces the valve to lock the hi-rail gear unit. When the rod 150 is moved from the end edge 221 to the intermediate opening 214 within the aperture 210, the valve is forced to unlock the hi-rail gear unit. From such unlock position, the rod 150 may be moved towards the second or the third ends 212, 213. When the rod 150 abuts the second end edge 222, such position of the rod 150 forces the valve system 120 to lift the hi-rail gear unit up from the ground. When the rod 150 abuts the third edge 223, such position of the rod 150 forces the valve system 120 to lower the hi-rail gear unit up towards the ground and to place it on the rails (or the ground).

In at least one embodiment, the second end edge 222 and the second end 212 are located above the intermediate opening 214, and the middle opening is located above the third edge and the third end 213. In at least one embodiment, the aperture has a form of a letter “T” rotated by approximately 90 degrees.

The plate 200 and the aperture 210 therein permits to guide the rod such that the rod 150 cannot pass to (in other words, the rod is restricted from passing to) the up or down position without being unlocked by passing through the intermediate opening 214 that forces the valve to unlock the hi-rail gear unit. While the rod 150 is moved in between the first end 211 and the intermediate opening 214, the valve system 120 unlocks the hi-rail gear unit. The aperture 210 permits to guide the rod 150 1) between lock and unlock positions, 2) between unlock and engaged position, and 3) between the unlock and disengaged position of the rod 150.

The form of the edges forces the rod 150 along a locking axis 201 (see FIG. 3) prior to permitting movement of the rod along a deployment axis 202, where the locking axis 201 and the deployment axis 202 are each perpendicular to the rod central axis 145. Thus, the aperture 210 in the plate 200 forces the operator to actuate the rod along the locking axis first, ensuring the hi-gear unit is properly unlocked, prior to deploying the cylinders down, or retracting them up.

Referring to FIG. 2A, the valve system 120 locks the hi-rail gear unit (depicted in FIG. 1) when the rod 150 of the multi-axis controller abuts the first end edge 221. The rod 150 abuts the first end edge 221 when the rod 150 is located in the first end 211, also referred to herein as an “lock position” of the rod. The valve system 120 unlocks the hi-rail gear unit (depicted in FIG. 1) when the rod 150 of the multi-axis controller abuts the intermediate edge 224 and is located in the intermediate opening 214, also referred to herein as an “unlock position” of the rod, as depicted in FIGS. 2B-2C.

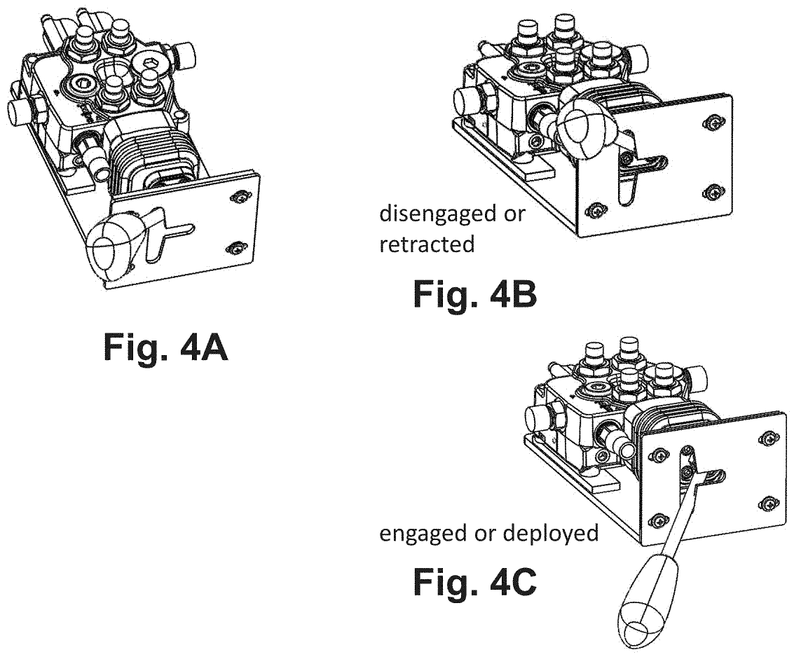

The valve system 120 moves the hi-rail gear unit up when the rod 150 abuts the second end edge 222, as depicted in FIGS. 4A-4B. When the rod 150 abuts the second end edge 222, it is located in the second end 212, also referred to herein as an “disengaged position” of the rod. The valve system 120 moves the hi-rail gear unit down when the rod 150 abuts the third end edge 223 as depicted in FIG. 4C. When the rod 150 abuts the third end edge 223, it is located in the third end 213, also referred to herein as an “engaged position” of the rod.

The locking can be made by controlling the valve controlling the hydraulic circuit that actuates the locking cylinder 2 and this is independent from the deployment or traction made by controlling the valve controlling the hydraulic circuit that actuates the deployment cylinder 15. However, the opposed cylinders of the same hi-rail gear unit (both deployment cylinders 15 or both locking cylinders 2) are expected to act simultaneously and are advantageously controlled simultaneously with the same hydraulic circuit.

Nonetheless, this independence between hydraulic circuits and valves can be repeated for the two hi-rail devices that can be present on a vehicle (front and rear).

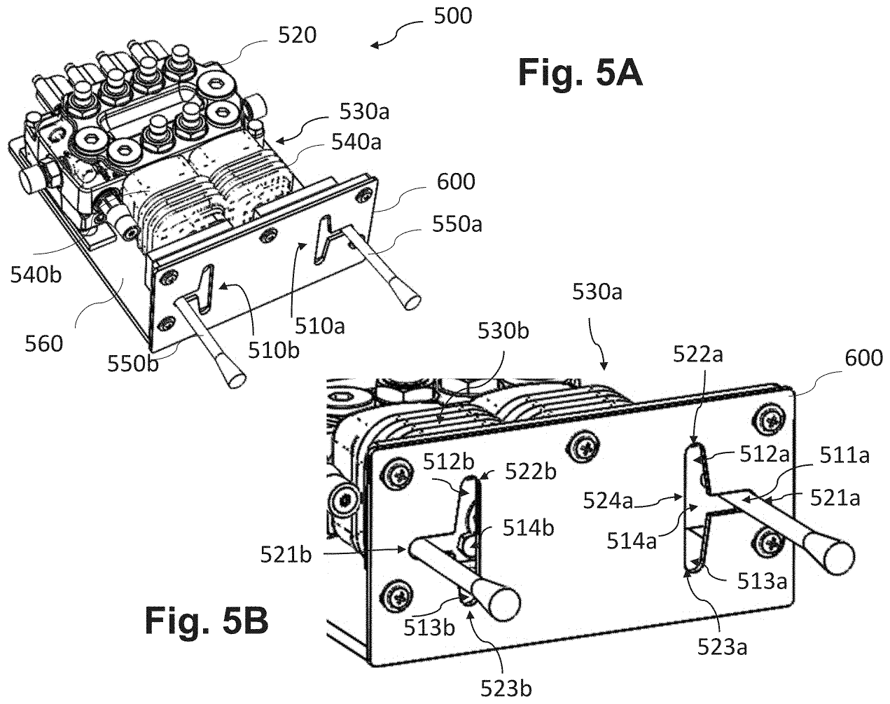

To this effect, referring now to FIGS. 5A-7 which depict another embodiment of the system for controlling deployment of a hi-rail gear unit, referred to herein as a multiple-rod system 500, the multiple-rod system 500 comprises more than one rod and a corresponding (respective) valve system. A dual-lever system can be used to operate, for example, a front and a rear unit, each with its own lever.

FIGS. 5A-7 depict an embodiment of a system for controlling deployment of a hi-rail gear unit which has two multi-axis controllers 530a, 530b, each having a rod 550a, 550b and a base 141, 142 (rods and bases are similar to those described above). In some embodiments, more than two rods may be connected to the valve system 120.

As depicted in FIG. 5A, system 500 has a plate 600 which has two apertures 510a, 510b. In some embodiments, the apertures 510a, 510b are oriented similarly to aperture 210 described above for plate 200. In some embodiments, two neighboring apertures 510a, 510b may be oriented such that when the first rod 550a is located in the first end edge 521a (lock position of the first rod 550a), it is located on one side (for example, on the right) from the intermediate opening 514a. The lock position of the second rod 550b may be on another side (for example, on the left) from a respective intermediate opening 514b of the second aperture 510b. For example, the first rod 550a may lock when it is located on the right from the unlock position (intermediate opening 524a of the first aperture 510a) and the second rod 550b may lock when it is located to the left from the unlock position (intermediate opening 524b of the second aperture 510b in FIG. 5B).

Such system 500 may deploy more than one hi-rail gear unit a valve system having a plurality of valves configured to deploy the hi-rail gear unit mechanically in response to being actuated.

As depicted in FIGS. 2A-6D, the plates 200, 600 are immovably attached to the valve system 120, 520, respectively. In apparatus 500, the bases 540a, 540b of two multi-axis controllers 530a, 530b are operatively attached to the valve system 520 and the plate 600 is also immovably attached to the valve system for example, by a support 560. In some embodiments, the plate 600 may be also attached to the bases 540a, 540b themselves. The plate 600 provides apertures 510a, 510b for the rods of the multi-axis controllers 530a, 530b.

FIGS. 5A, 5B depict the apparatus 500 when both rods 550a, 550b are in lock positions.

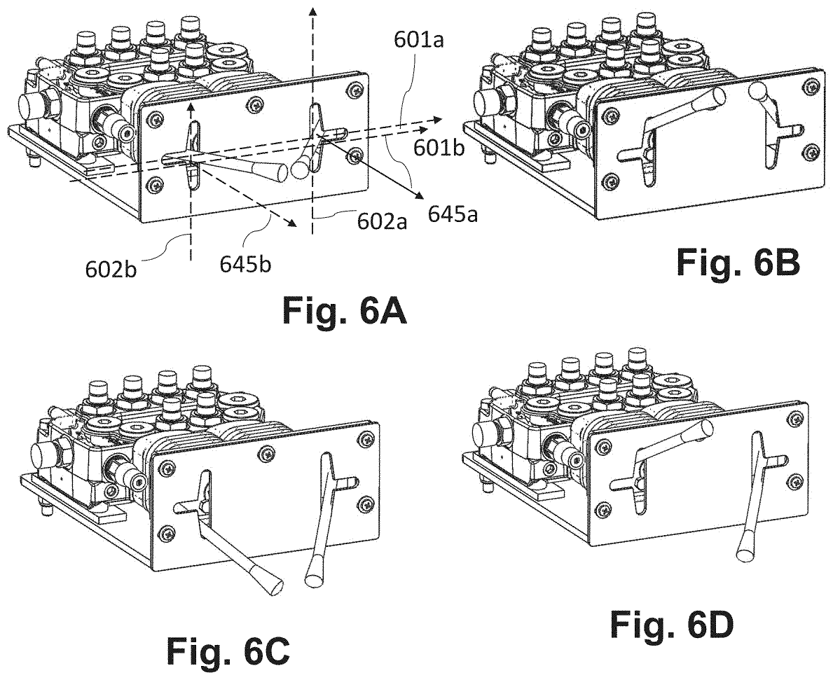

FIG. 6A depicts the apparatus 500 when both rods 550a, 550b are in unlock positions in intermediate openings 514a, 514b of the apertures of the plate 600. FIG. 6B depicts the apparatus 500 when both rods 550a, 550b are in engaged positions in second end 512a, 512b of the apertures of the plate 600. FIG. 6C depicts the apparatus 500 when both rods 550a, 550b are in disengaged positions in third ends 513a, 513b of the apertures of the plate 600.

FIG. 6D depicts the apparatus 500 when one rod 550a is in engaged position and the other rod 550b in the disengaged position.

With reference to FIGS. 6A-6D, to lock and unlock the hi-rail gear unit(s), the rods 550a, 550b are forced, by the apertures 510a, 510b in the plate 600, to move along a locking axis 601a, 601b. To deploy the hi-rail gear unit(s), the rods 550a, 550b are forced, by the apertures 510a, 510b in the plate 600, to move along a deployment axis 602a, 602b.

The plate 600 has a first aperture 510a configured to receive the first rod 550a and to force the first rod 550a along a first locking axis 601a prior to permitting movement of the first rod 550a along a first deployment axis 602a. The first locking axis 601a and the first deployment axis 602a are approximately perpendicular to the first rod central axis 645a. The plate 600 also may have a second aperture 510b configured to receive the second rod 550b and to force the second rod 550b along the second locking axis 601b prior to permitting movement of the second rod 550b along a second deployment axis 602b, the second locking axis 601b and the second deployment axis 602b being approximately perpendicular to the second rod central axis 645b.

In some embodiments, locking axis 601a, 601b coincide with each other. Alternatively, the first locking axis 601a and the second locking axis 601b may be parallel to each other. In some embodiments, the first deployment axis 602a is parallel to a second deployment axis 602b.

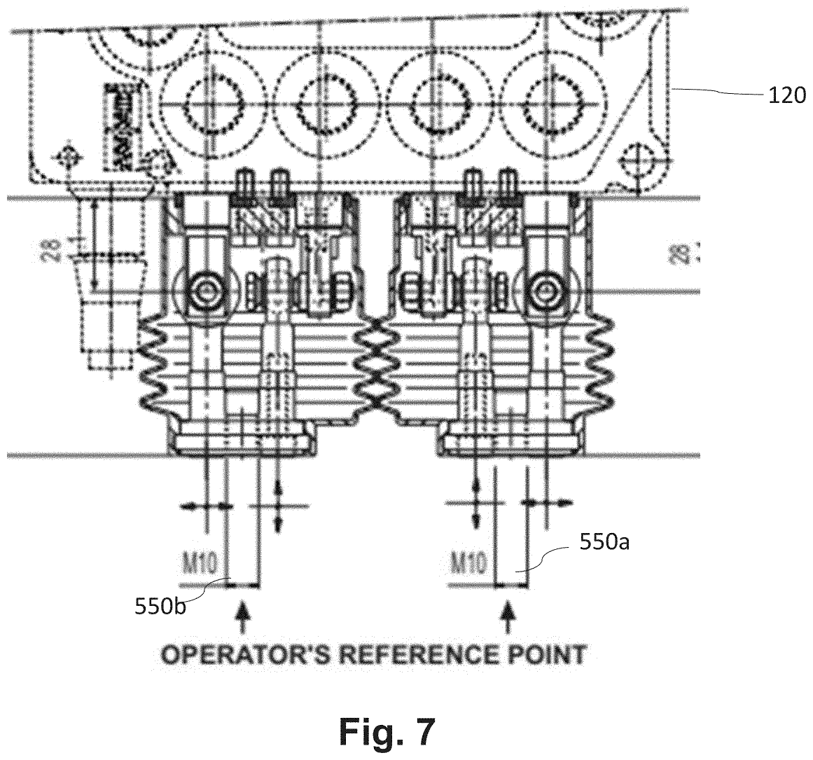

According to an embodiment, and now referring to FIG. 7, the valve system 120 comprises spool valves. According to an embodiment, each lever or rod 150 (or each of the rods 550a, 550b) drives two spool valves, each of the two spool valves being actuated only when the lever or rod (150, or 550a, 550b) travels along one of the two confined axes (locking axis, or deployment axis, respectively). In other words, the one-lever system (FIGS. 2A-4C) comprises two spool valves, and the two-lever system (FIGS. 5A-6D) comprises four spool valves.

Spool valves can be provided as a small cylinder which acts as a discrete and directional valve to allow the hydraulic cylinder associated thereto to be extended or retracted. The spool valve typically comprises ports, such as three ports, which can be selectively obstructed or unobstructed to allow the spool valve to be in an open configuration or in a closed configuration to let pressurized fluid flow or remain static, respectively, and thereby control the hydraulic cylinder associated thereto to be in extended or in retracted position in accordance with the open or closed configuration of the spool valve.

The spool valves in the valve system can be either a metering spool valve or a non-metering spool valve, depending on whether it comprises geometrical elements therein (such as edges or a notch) which allow measuring the amount of fluid flowing therein. According to an embodiment, one of the two spool valves associated to a lever or rod is a non-metering spool valve, and the other one of the two spool valves associated to a lever or rod is a metering spool valve.

The non-metering spool valve should be fluidly connected to the locking cylinder 2 to control its position (in a locked or unlocked configuration). Using a non-metering spool valve allows for better feedback (haptic feedback) for the operator operating the corresponding lever or rod in the locking axis to feel the on/off configuration of the lever/spool valve/locking cylinder. In view of the fact that that the locked/unlocked configuration feature which matters with the locking cylinder 2, the non-metering spool valve gives more tactile feedback of the on/off nature of the spool valve and it is therefore appropriate for this use.

Within the pair of spool valves connected to a lever or rod (150, or 550a, 550b), the metering spool valve should be fluidly connected to the deployment cylinder 15 to control its position (in a retracted or deployed configuration). Using a metering spool valve allows for better feedback (haptic feedback) for the operator operating the corresponding lever or rod in the locking axis to feel the deployment speed or retraction speed of the deployment cylinder. In view of the fact that the speed of deployment and retraction is a feature which matters with the deployment cylinder 15, the metering spool valve gives more tactile feedback of the speed of the cylinder and it is therefore appropriate for this use. In other words, the metering provides a better feel for the deployment cylinders and allows to gauge the deployment speed of the individual cylinders better.

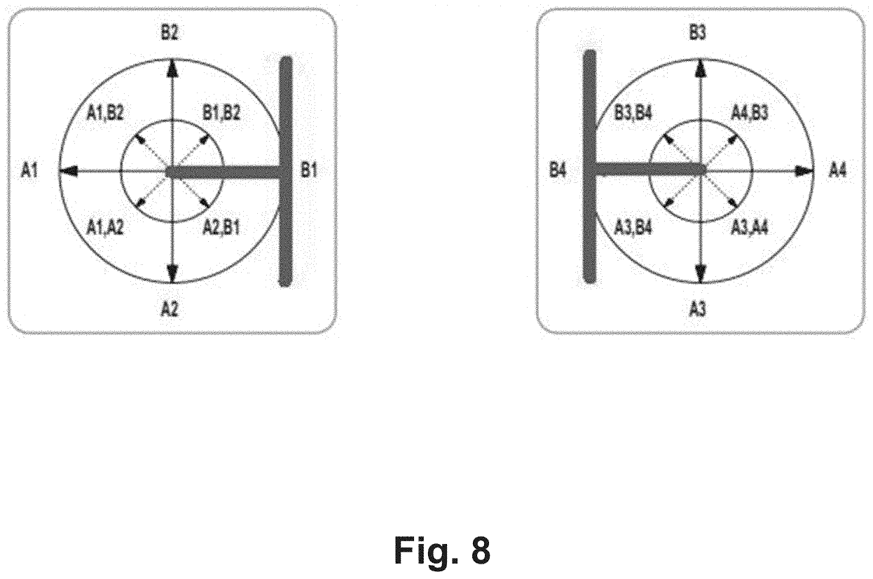

Now referring to FIG. 8, there is shown a two-dimensional representation of the positions that would be possible for a lever of the spool valve system 120 (left for the rod 550a, right for the rod 550b). The plane 200 is used for guiding and constraining of the rod's movement controlling the valve mechanism to prevent the actuation of the deployment spool before the locking spool is fully stroked. In FIG. 8, the additional thick lines show that B1 and B4 (locking cylinders and their respective spool valves) are always held actuated (cylinders unlocked) while B2-A2 and B3-A3 are being actuated (deployment cylinders and their respective spool valves are free to move in the vertical direction only when B1 or B4 are). According to an embodiment, the locking cylinder spool valves do not go to A1 and A4 positions, as the internal cylinder springs ensure they extend back out.

While preferred embodiments have been described above and illustrated in the accompanying drawings, it will be evident to those skilled in the art that modifications may be made without departing from this disclosure. Such modifications are considered as possible variants comprised in the scope of the disclosure.

1. An apparatus for controlling deployment of a hi-rail gear unit, the system comprising:
a valve system having a plurality of valves, wherein some of the valves are configured to actuate a deployment cylinder that deploys the hi-rail gear unit in a deployment configuration or retracts the hi-rail gear unit in a retraction configuration mechanically in response to being actuated, wherein some of the valves are configured to actuate a locking cylinder that locks or unlocks the hi-rail gear unit in one of said configurations in response to being actuated;
a first multi-axis controller connected to the valve system and having a first rod configured to move freely by pivoting on a first base from, towards and about a first rod central axis, the positions of the first multi-axis controller including a first lock position, a first unlock position, a first engaged position and a first disengaged position; and
a mechanical linkage plate attached to the valve system, the mechanical linkage plate having a first aperture configured to receive the first rod and to force the first rod along a first locking axis prior to permitting movement of the first rod along a first deployment axis.

2. The apparatus of claim 1 wherein the aperture has a form of a “T”.

3. The apparatus of claim 1, wherein the first base is attached to the valve system.

4. The apparatus of claim 1, wherein the first locking axis and the first deployment axis are approximately perpendicular to, and are both approximately perpendicular to the first rod central axis.

5. The apparatus of claim 1, wherein:
the valve system locks the hi-rail gear when the first rod is in the first lock position; and
the valve system unlocks the hi-rail gear when the first rod is in the first unlock position.

6. The apparatus of claim 5, wherein:
the valve system moves the hi-rail gear up when the first rod is in the first disengaged position; and
the valve system moves the hi-rail gear down when the first rod is in the first engaged position.

7. The apparatus of claim 6, wherein the first aperture is configured to guide the first rod only 1) between the first lock position and the first unlock position, 2) between the first unlock position and the first engaged position, and 3) between the first unlock position and the first disengaged position, while prohibiting a guiding of the first rod between other positions.

8. The apparatus of claim 1, wherein the deployment cylinder is a hydraulic cylinder which unfolds for deployment or folds for retraction arms forming a linkage of the hi-rail gear unit.

9. The apparatus of claim 8, wherein the locking cylinder is a hydraulic cylinder comprising a compression spring for safety and which holds the arms forming the linkage of the hi-rail gear unit either unfolded in deployment or folded in retraction.

10. The apparatus of claim 1, further comprising a second multi-axis controller attached to the valve system via a second base, the second multi-axis controller having a second rod configured to move freely by pivoting on a second base from, towards and about a second rod central axis, and wherein the mechanical linkage plate has a second aperture configured to receive the second rod and to force the second rod along a second locking axis prior to permitting movement of the second rod along a second deployment axis, the second locking axis and the second deployment axis being approximately perpendicular to the second rod central axis.

11. A method for controlling sequential unlocking, deployment or retraction, and locking of a hi-rail gear unit, the system comprising:
providing a valve system having a plurality of valves, wherein some of the valves are configured to actuate a deployment cylinder that deploys the hi-rail gear unit in a deployment configuration or retracts the hi-rail gear unit in a retraction configuration mechanically in response to being actuated, wherein some of the valves are configured to actuate a locking cylinder that locks or unlocks the hi-rail gear unit in one of said configurations in response to being actuated;
connecting a first multi-axis controller to the valve system and having a first rod configured to move freely by pivoting on a first base from, towards and about a first rod central axis, the positions of the first multi-axis controller including a first lock position, a first unlock position, a first engaged position and a first disengaged position; and
guiding the first rod on the first multi-axis controller by using a mechanical linkage plate attached to the valve system, the mechanical linkage plate having a first aperture configured to receive the first rod and to force the first rod along a first locking axis prior to permitting movement of the first rod along a first deployment axis.

12. The method of claim 11 wherein guiding the first rod comprises using the aperture having a form of a “T”.

13. The method of claim 11, further comprising attaching the first base to the valve system.

14. The method of claim 11, wherein guiding the first rod comprises providing the first locking axis approximately perpendicular to the first deployment axis and approximately perpendicular to the first rod central axis.

15. The method of claim 11, further comprising:
locking the hi-rail gear using the valve system when the first rod is in the first lock position; and
unlocking the hi-rail gear using the valve system when the first rod is in the first unlock position.

16. The method of claim 15, further comprising:
retracting the hi-rail gear unit up using the valve system when the first rod is in the first disengaged position; and
deploying the hi-rail gear unit down using the valve system when the first rod is in the first engaged position.

17. The method of claim 16, wherein guiding the first rod comprises using the first aperture which is configured to guide the first rod only 1) between the first lock position and the first unlock position, 2) between the first unlock position and the first engaged position, and 3) between the first unlock position and the first disengaged position, while prohibiting a guiding of the first rod between other positions.

18. The method of claim 11, wherein actuating the deployment cylinder comprises actuating a hydraulic cylinder which unfolds for deployment or folds for retraction arms forming a linkage of the hi-rail gear unit.

19. The method of claim 18, wherein actuating the locking cylinder comprises actuating a hydraulic cylinder comprising a compression spring for safety and which holds the arms forming the linkage of the hi-rail gear unit either unfolded in deployment or folded in retraction.

20. The method of claim 11, further comprising providing a second multi-axis controller attached to the valve system via a second base, the second multi-axis controller having a second rod configured to move freely by pivoting on a second base from, towards and about a second rod central axis, and wherein the guiding comprises provided a mechanical linkage plate that has a second aperture configured to receive the second rod and to force the second rod along a second locking axis prior to permitting movement of the second rod along a second deployment axis, the second locking axis and the second deployment axis being approximately perpendicular to each other.
